(19) United States
(12) Patent Application Publication
(10) Pub. No.: US 2025/0038258 A1
(43) Pub. Date: Jan. 30, 2025

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Sanghyung KIM, Yongin-si (KR); Tae Hyon BAE, Yongin-si (KR); Harim LEE, Yongin-si (KR); Seunghyeon SON, Yongin-si (KR); Youngkyeong SHIN, Yongin-si (KR); Sanghoon KIM, Yongin-si (KR); Arum YU, Yongin-si (KR)

(21) Appl. No.: 18/667,775

(22) Filed: May 17, 2024

(30) Foreign Application Priority Data
Jul. 27, 2023 (KR) 10-2023-0098392

(51) Int. Cl. H01M 10/0567; H01M 10/0525; H01M 10/0568; H01M 10/0569; H01M 10/42

(52) U.S. Cl. CPC H01M 10/0567; H01M 10/0525; H01M 10/0568; H01M 10/0569; H01M 10/4235; H01M 2300/004

(57) ABSTRACT

Disclosed are an electrolyte for a rechargeable lithium battery and a rechargeable lithium battery including the same, the electrolyte for a rechargeable lithium battery including a lithium salt; a non-aqueous organic solvent; a first additive represented by Chemical Formula 1; and a second additive represented by Chemical Formula 2. The description of each of the chemical formulas is provided in the specification.

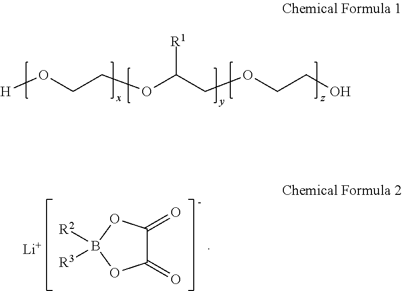

### CROSS-REFERENCE TO RELATED APPLICATION

The present application claims priority to and the benefit of Korean Patent Application No. 10-2023-0098392, filed on Jul. 27, 2023, in the Korean Intellectual Property Office, the entire content of which is hereby incorporated by reference.

### BACKGROUND

### 1. Field

An electrolyte for a rechargeable lithium battery and a rechargeable lithium battery including the same are disclosed.

### 2. Description of the Related Art

Recently, with the rapid spread of electronic devices that use batteries, such as mobile phones, laptop computers, and electric vehicles, the demand for rechargeable batteries having high energy density and high capacity is rapidly increasing. Accordingly, research and development to improve the performance of rechargeable lithium batteries is actively underway.

A rechargeable lithium battery includes a positive electrode and a negative electrode including an active material capable of intercalating and deintercalating lithium ions, and an electrolyte, and electrical energy is produced through oxidation and reduction reactions if lithium ions are intercalated/deintercalated from the positive electrode and negative electrode.

One of the recent development directions for rechargeable lithium batteries is to improve high-voltage and/or high-temperature characteristics. In general, rechargeable lithium batteries have a problem of reduced cycle-life and/or increased resistance at high voltage and/or high temperature.

### SUMMARY

Some embodiments provide an electrolyte for a rechargeable lithium battery that improves high-voltage and/or high-temperature characteristics of a rechargeable lithium battery.

Some embodiments provide a rechargeable lithium battery including the electrolyte for a rechargeable lithium battery.

Some embodiments provide an electrolyte for a rechargeable lithium battery including a lithium salt; a non-aqueous organic solvent; a first additive represented by Chemical Formula 1; and a second additive represented by Chemical Formula 2:

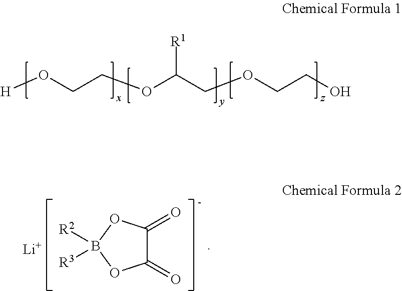

Some embodiments provide a rechargeable lithium battery including a positive electrode including a positive electrode active material; a negative electrode including a negative electrode active material; and the electrolyte.

The electrolyte for a rechargeable lithium battery according to some embodiments can improve high-voltage and/or high-temperature characteristics of a rechargeable lithium battery.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIGS. 1-4 are schematic views showing rechargeable lithium batteries according to some embodiments.

### DETAILED DESCRIPTION

Hereinafter, embodiments of the present disclosure will be described in more detail. However, these embodiments are examples, the present disclosure is not limited thereto and the present disclosure is defined by the scope of the appended claims, and equivalents thereof.

As used herein, if specific definition is not otherwise provided, it will be understood that if an element such as a layer, film, region, or substrate is referred to as being “on” another element, it can be directly on the other element or intervening elements may also be present.

As used herein, if specific definition is not otherwise provided, the singular may also include the plural. In some embodiments, unless otherwise specified, “A or B” may mean “including A, including B, or including A and B.”

As used herein, “a combination thereof” may mean a mixture of constituents, a stack, a composite, a copolymer, an alloy, a blend, and/or a reaction product.

As used herein, if a definition is not otherwise provided, in chemical formulae, hydrogen is bonded at a position if a chemical bond is not drawn where supposed to be given.

As used herein, if specific definition is not otherwise provided, “*” indicates a point where the same or different atom or chemical formula is linked.

As used herein, “fluoroalkyl group” refers to an alkyl group in which some or all of the hydrogen atoms are replaced by fluorine atoms.

As used herein, “perfluoroalkyl group” refers to an alkyl group in which all hydrogen atoms are replaced by fluorine atoms.

In the present specification, “number average molecular weight” may be a value measured by gel permeation chromatography (GPC, PL GPC220, Agilent Technologies) and corrected with a cubic function using polystyrene.

### Electrolyte

Some embodiments provide an electrolyte for a rechargeable lithium battery including a lithium salt; a non-aqueous organic solvent; a first additive represented by Chemical Formula 1; and a second additive represented by Chemical Formula 2:

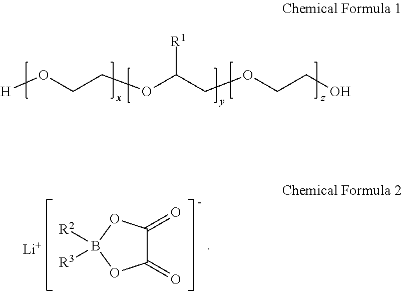

The first additive functions as a surfactant having both hydrophilic and hydrophobic groups in one molecule. The first additive includes a *—[O—CH(R¹)—CH₂]_{y}—* in a main chain (e.g., in a block at the center), with a *—[O—CH₂—CH₂]ₓ—* block and a *—[O—CH₂—CH₂]_{z}—* block on both sides, respectively (e.g., at two respective sides of *—[O—CH(R¹)—CH₂]_{y}—*). Herein, the *—[O—CH(R¹)—CH₂]_{y}—* block is a hydrophobic block, and the *—[O—CH₂—CH₂]ₓ—* block and *—[O—CH₂—CH₂]_{z}—* block are each hydrophilic blocks.

Accordingly, if an electrolyte including the first additive is used, wettability of the positive electrode and negative electrode is improved, lithium cations (Li⁺) are uniformly formed at the interface between the positive electrode and the electrolyte, and a stable SEI film is formed at the interface between the negative electrode and the electrolyte, thereby suppressing or reducing the precipitation of lithium dendrites.

In some embodiments, the second additive is the compound represented by Chemical Formula 2, where the fluoro group of the compound stabilizes the lithium salt (e.g., LiPF₆). Accordingly, if an electrolyte including the second additive is used, production of HF may be suppressed or reduced, and transition metal elution from the positive electrode active material and damage to the SEI film at the interface between the negative electrode and the electrolyte may be prevented or reduced.

Therefore, if an electrolyte for a rechargeable lithium battery including the first additive and the second additive is used, elution of transition metals from the positive electrode active material is suppressed or reduced and a stable SEI film is formed on the negative electrode surface, thereby improving high-voltage and/or high-temperature characteristics of the rechargeable lithium battery.

Hereinafter, an electrolyte for a rechargeable lithium battery according to some embodiments will be described in more detail.

### First Additive

In Chemical Formula 1, R¹ is a hydrogen atom or a C1 to C10 alkyl group.

For example, R¹ may be a methyl group.

In Chemical Formula 1, x, y, and z are independently an integer of 1 to 20.

Herein, a mole ratio of x:y may be about 10:1 to about 1:10, about 5:1 to about 1:5, or about 3:1 to about 1:3. In some embodiments, the mole ratio of y:z may be about 10:1 to about 1:10, about 5:1 to about 1:5, or about 3:1 to about 1:3.

The number average molecular weight of the first additive may be about 500 to about 10,000 g/mol, about 700 to about 8,000 g/mol, or about 1,000 to about 2,000 g/mol.

If the number average molecular weight of the first additive exceeds the above ranges, viscosity of the electrolyte including the first additive may increase excessively, and wettability to the positive and negative electrodes may actually decrease. If the number average molecular weight of the first additive is less than the above ranges, the effect as a surfactant may be minimal or reduced.

A representative example of the first additive is as follows:

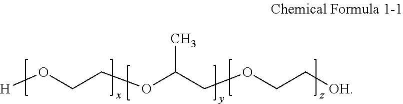

The first additive represented by Chemical Formula 1-1 is poly(ethylene glycol)-b-poly(propylene glycol)-b-poly(ethylene glycol) (PEG-b-PPG-b-PEG).

In Chemical Formula 1-1, the definitions of x, y, and z are as described above.

### Second Additive

In Chemical Formula 2, R² and R³ are each independently a halogen atom, or a C1 to C10 fluoroalkyl group. Herein, the halogen atom may be a fluorine atom, a chlorine atom, a bromine atom, or an iodine atom.

For example, both R² and R³ may each be fluorine atoms.

A representative example of the second additive is as follows:

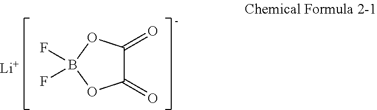

The second additive represented by Chemical Formula 2-1 is lithium difluoro(oxalato)borate (LiDFOB).

### Contents of First Additive and Second Additive

The first additive may be included in an amount of about 0.1 to about 5 wt %, about 0.3 to about 4 wt %, or about 0.5 to about 3 wt % based on a total amount of the electrolyte.

If the first additive is included in excess of the above ranges, viscosity of the electrolyte including the first additive may increase excessively, and wettability of the positive electrode and the negative electrode may actually decrease. If the content of the first additive is included in a small amount below the above ranges, the effect as a surfactant may be minimal or reduced.

The second additive may be included in an amount of about 0.1 to about 5 wt %, about 0.25 to about 2 wt %, or about 0.25 to about 1.5 wt % based on the total amount of the electrolyte.

If the second additive is included in excess of the above ranges, a side reaction may occur. If the content of the second additive is included in a small amount below the above ranges, the effect may be minimal or reduced.

A weight ratio of the first additive and the second additive may be about 5:1 to about 1:10, about 2:1 to about 3:10, or about 2:1 to about 1:3.

Within these ranges, the effects of the first additive and the second additive can be harmonized (e.g., provide a synergistic effect).

### Non-Aqueous Organic Solvent

The non-aqueous organic solvent serves as a medium that transmits ions taking part in the electrochemical reaction of a battery.

The non-aqueous organic solvent may be a carbonate-based, ester-based, ether-based, ketone-based, and/or alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethylacetate, methyl propionate, ethyl propionate, propyl propionate, decanolide, mevalonolactone, valerolactone, caprolactone, and/or the like

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. The ketone-based solvent may include cyclohexanone and/or the like. The alcohol-based solvent may include ethyl alcohol, isopropyl alcohol, and/or the like, and the aprotic solvent may include nitriles such as R—CN (wherein R is a C2 to C20 linear, branched, and/or cyclic hydrocarbon group, a double bond, an aromatic ring, and/or an ether group), amides such as, for example, dimethylformamide, dioxolanes such as, for example, 1,3-dioxolane or 1,4-dioxolane, sulfolanes, and/or the like.

The non-aqueous organic solvent may be used alone or in a combination of two or more.

In some embodiments, if the non-aqueous organic solvent is used in a combination of two or more, the non-aqueous organic solvent may include a carbonate-based solvent and a propionate-based solvent.

The propionate-based solvent may be included in an amount of greater than or equal to about 70 volume % based on a total amount of the non-aqueous organic solvent. In some embodiments, high-voltage and/or high-temperature characteristics of the rechargeable lithium battery can be improved.

For example, the non-aqueous organic solvent may be a mixed solvent of ethylene carbonate (EC), propylene carbonate (PC), and propyl propionate (PP).

### Lithium Salt

The lithium salt dissolved in the organic solvent supplies lithium ions in a battery, enables a basic operation of a rechargeable lithium battery, and improves transportation of the lithium ions between positive and negative electrodes. LiPF₆ may be used as the lithium salt, and its structure can be stabilized by the second additive.

A concentration of the lithium salt may be about 0.1 M to about 2.0 M.

### Rechargeable Lithium Battery

Some embodiments provide a rechargeable lithium battery including a positive electrode including a positive electrode active material; a negative electrode including a negative electrode active material; and the electrolyte.

### Charge Upper Limit Voltage

As the rechargeable lithium battery according to some embodiments includes the electrolyte of the above-described embodiment, an increase in battery thickness and a decrease in cycle-life can be suppressed or reduced even at high voltage.

For example, the rechargeable lithium battery may have an upper charge limit voltage of greater than or equal to about 4.5 V.

Hereinafter, descriptions that overlap with the above may not be repeated, and a rechargeable lithium battery according to some embodiments will be described in more detail.

### Positive Electrode Active Material

The positive electrode active material may be a compound (lithiated intercalation compound) capable of intercalating and deintercalating lithium. In some embodiments, one or more types (or kinds) of composite oxides of lithium and a metal selected from cobalt, manganese, nickel, and combinations thereof may be used.

The composite oxide may be a lithium transition metal composite oxide, and examples thereof may include lithium nickel-based oxide, lithium cobalt-based oxide, lithium manganese-based oxide, a lithium iron phosphate-based compound, cobalt-free lithium nickel-manganese-based oxide, or a combination thereof.

As an example, a compound represented by any of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

As an example, the positive electrode active material may have a nickel content of greater than or equal to about 80 mol %, greater than or equal to about 85 mol %, greater than or equal to about 90 mol %, greater than or equal to about 91 mol %, or greater than or equal to about 94 mol % based on 100 mol % of metals excluding lithium in the lithium transition metal composite oxide, and may be a high nickel-based positive electrode active material having a nickel content of less than or equal to about 99 mol %. The high-nickel-based positive electrode active materials can achieve high capacity and can be applied to high-capacity, high-density rechargeable lithium batteries.

The positive electrode active material may be, for example, a lithium nickel-based oxide represented by Chemical Formula 11, a lithium cobalt-based oxide represented by Chemical Formula 12, a lithium iron phosphate-based compound represented by Chemical Formula 13, a cobalt-free lithium nickel manganese-based oxide represented by Chemical Formula 14, or a combination thereof.

Liₐ₁Niₓ₁M¹_{y1}M²_{z1}O_{2-b1}X_{b1} Chemical Formula 11

In Chemical Formula 11, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² are each independently one or more elements selected from Al, B, Ba, Ca, Ce, Co, Cr, Cu, Fe, Mg, Mn, Mo, Nb, Si, Sn, Sr, Ti, V, W, and Zr, and X is one or more elements selected from F, P, and S.

In some embodiments, in Chemical Formula 11, 0.6≤x1≤1, 0≤y1≤0.4, and 0≤z1≤0.4, or 0.8≤x1≤1, 0≤y1≤0.2, and 0≤z1≤0.2.

Liₐ₂Coₓ₂M³_{y2}O_{2-b2}X_{b2} Chemical Formula 12

In Chemical Formula 12, 0.9≤a2≤1.8, 0.7≤x2≤1, 0≤y2≤0.3, 0.9≤x2+y2≤1.1, and 0≤b2≤0.1, M³ is one or more elements selected from Al, B, Ba, Ca, Ce, Cr, Cu, Fe, Mg, Mn, Mo, Ni, Se, Si, Sn, Sr, Ti, V, W, Y, Zn, and Zr, and X is one or more elements selected from F, P, and S.

Liₐ₃Feₓ₃M⁴_{y3}PO_{4-b3}X_{b3} Chemical Formula 13

In Chemical Formula 13, 0.9≤a3≤1.8, 0.6≤x3≤1, 0≤y3≤0.4, and 0≤b3≤0.1, M⁴ is one or more elements selected from Al, B, Ba, Ca, Ce, Co, Cr, Cu, Mg, Mn, Mo, Ni, Se, Si, Sn, Sr, Ti, V, W, Y, Zn, and Zr, and X is one or more elements selected from F, P, and S.

Liₐ₄Niₓ₄Mn_{y4}M⁵_{z4}O_{2-b4}X_{b4} Chemical Formula 14

In Chemical Formula 14, 0.9≤a4≤1.8, 0.8≤x4<1, 0<y4≤0.2, 0≤z4≤0.2, 0.9≤x4+y4+z4≤1.1, and 0≤b4≤0.1 M⁵ is one or more elements selected from Al, B, Ba, Ca, Ce, Cr, Fe, Mg, Mo, Nb, Si, Sn, Sr, Ti, V, W, and Zr, and X is one or more elements selected from F, P, and S.

In some embodiments, the electrolyte of the above-described embodiment can significantly improve high-voltage and/or high-temperature characteristics of a battery using the lithium cobalt-based oxide represented by Chemical Formula 12.

### Positive Electrode

The positive electrode for a rechargeable lithium battery may include a current collector and a positive electrode active material layer on the current collector. The positive electrode active material layer may include a positive electrode active material and may further include a binder and/or a conductive material (e.g., an electrically conductive material).

For example, the positive electrode may further include an additive that can function as a sacrificial positive electrode.

A content of the positive electrode active material may be about 90 wt % to about 99.5 wt %, and a content of the binder and the conductive material may be about 0.5 wt % to about 5 wt %, respectively based on 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity (e.g., electrical conductivity) to the electrode. Any suitable material that does not cause chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder and/or a metal fiber; a conductive polymer (e.g., an electrically conductive polymer) such as a polyphenylene derivative; or a mixture thereof.

Al may be used as the current collector, but is not limited thereto.

### Negative Electrode Active Material

The negative electrode active material may be a material that reversibly intercalates/deintercalates lithium ions, a lithium metal, a lithium metal alloy, a material capable of doping and dedoping lithium, and/or a transition metal oxide.

The material that reversibly intercalates/deintercalates lithium ions may include a carbon-based negative electrode active material, for example, crystalline carbon, amorphous carbon, or a combination thereof. The crystalline carbon may be graphite such as non-shaped, sheet-shaped, flake-shaped, sphere-shaped, and/or fiber-shaped natural graphite and/or artificial graphite. The amorphous carbon may be a soft carbon, a hard carbon, a mesophase pitch carbonization product, calcined coke, and/or the like.

The lithium metal alloy may include lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material and/or a Sn-based negative electrode active material. The Si-based negative electrode active material may include silicon, a silicon-carbon composite, SiOₓ (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be a composite of silicon and amorphous carbon. According to some embodiments, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

### Negative Electrode

A negative electrode for a rechargeable lithium battery includes a current collector and a negative electrode active material layer on the current collector. The negative electrode active material layer includes a negative electrode active material and may further include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0.5 wt % to about 5 wt % of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

If an aqueous binder is used as the negative electrode binder, it may further include a cellulose-based compound capable of imparting or increasing viscosity. The cellulose-based compound includes one or more of carboxylmethyl cellulose, hydroxypropylmethyl cellulose, methyl cellulose, or alkali metal salts thereof. The alkali metal may be Na, K, and/or Li.

The dry binder may be a polymer material capable of being fiberized, and may be, for example, polytetrafluoroethylene, polyvinylidene fluoride, polyvinylidene fluoride-hexafluoropropylene copolymer, polyethylene oxide, or a combination thereof. The conductive material is included to provide electrode conductivity (e.g., electrical conductivity), and any suitable electrically conductive material may be used as a conductive material unless it causes a chemical change (e.g., causes an undesirable chemical change in the rechargeable lithium battery). Examples of the conductive material may be a carbon-based material such as natural graphite, artificial graphite, carbon black, acetylene black, ketjen black, a carbon fiber, a carbon nanofiber, a carbon nanotube, and the like; a metal-based material such as copper, nickel, aluminum silver, and the like in a form of a metal powder and/or a metal fiber; a conductive polymer (e.g., an electrically conductive polymer) such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal (e.g., an electrically conductive metal), and a combination thereof, but is not limited thereto.

### Separator

Depending on the type (or kind) of the rechargeable lithium battery, a separator may be present between the positive electrode and the negative electrode. The separator may include polyethylene, polypropylene, polyvinylidene fluoride, or a multilayer film of two or more layers thereof, and/or a mixed multilayer film such as a polyethylene/polypropylene two-layer separator, polyethylene/polypropylene/polyethylene three-layer separator, polypropylene/polyethylene/polypropylene three-layer separator, and/or the like.

The separator may include a porous substrate and a coating layer including an organic material, an inorganic material, or a combination thereof on one or both surfaces (e.g., two opposing surfaces) of the porous substrate.

The porous substrate may be a polymer film formed of any one selected from a polymer polyolefin such as, for example, polyethylene and polypropylene, polyester such as, for example, polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer and/or a (meth)acrylic-based polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed together in one coating layer, or a coating layer including an organic material and a coating layer including an inorganic material may be stacked.

### Rechargeable Lithium Battery

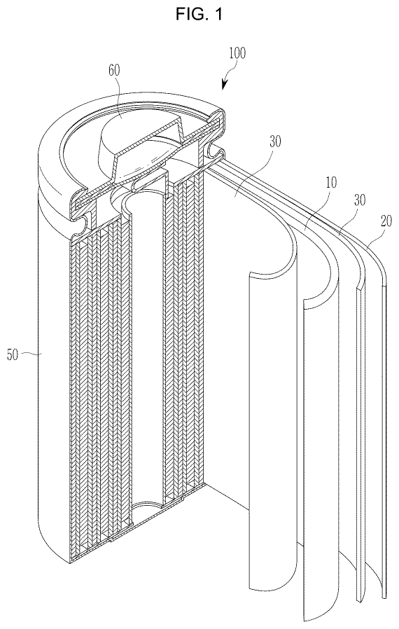

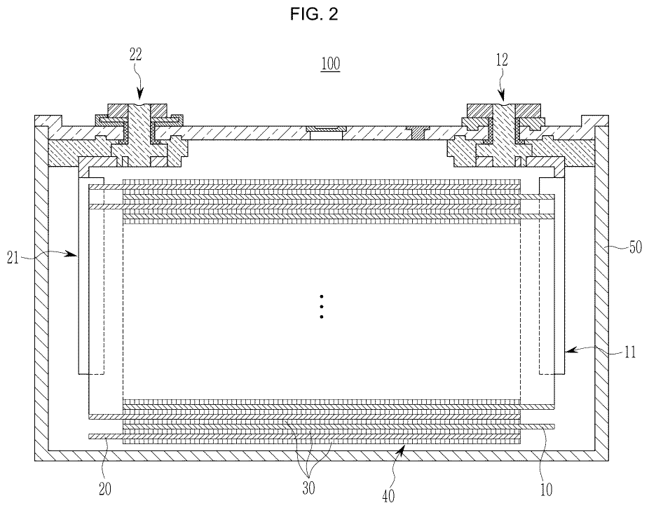

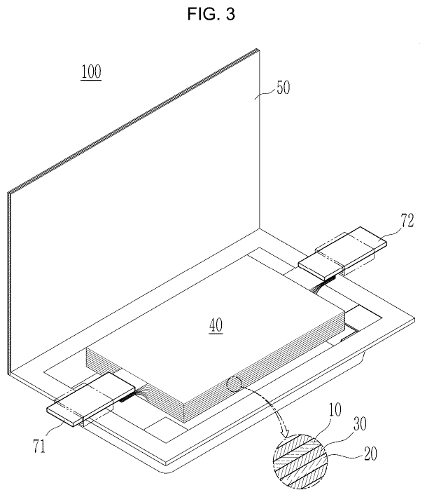

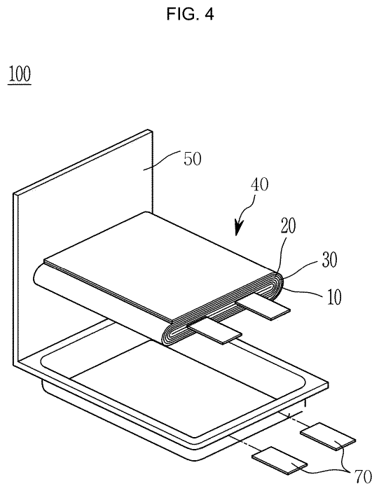

The rechargeable lithium battery may be classified into cylindrical, prismatic, pouch, or coin-type batteries, and the like depending on their shape. FIGS. 1-4 are schematic views illustrating rechargeable lithium batteries according to embodiments. FIG. 1 shows a cylindrical battery, FIG. 2 shows a prismatic battery, and FIGS. 3-4 show pouch-type batteries. Referring to FIGS. 1-4, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte. The rechargeable lithium battery 100 may include a sealing member 60 that seals the case 50, as shown in FIG. 1. In FIG. 2, the rechargeable lithium battery 100 may include a positive lead tab 11, a positive terminal 12, a negative lead tab 21, and a negative terminal 22. As shown in FIGS. 3-4, the rechargeable lithium battery 100 may include an electrode tab 70 (FIG. 4), which may be, for example, a positive electrode tab 71 and a negative electrode tab 72 (FIG. 3) that serve as an electrical path for inducing the current formed in the electrode assembly 40 to the outside.

The rechargeable lithium battery according to some embodiments may be applied to automobiles, mobile phones, and/or various suitable types (or kinds) of electrical devices, but the present disclosure is not limited thereto.

Hereinafter, examples of the present disclosure and comparative examples are described. These examples, however, are not in any sense to be interpreted as limiting the scope of the present disclosure.

### Preparation of Electrolyte

### Example 1

1.3 M LiPF₆ was dissolved in a non-aqueous organic solvent in which ethylene carbonate (EC), propylene carbonate (PC), and propyl propionate (PP) were mixed together in a volume ratio of 10:15:75, and 0.5 wt % of the first additive and 0.25 wt % of the second additive were added thereto to prepare an electrolyte.

The first additive represented by Chemical Formula 1-1-1 was used:

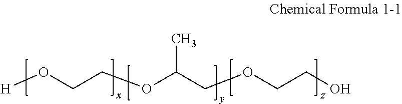

Poly(ethylene glycol)-block-poly(propylene glycol)-block-poly(ethylene glycol) (PEG-b-PPG-b-PEG. CAS No.: 9003-11-6, x=1-20, y=1-20, z=1-20, number average molecular weight: 1,100 g/mol)

The second additive represented by Chemical Formula 2-1 was used:

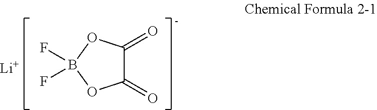

Lithium difluoro(oxalato)borate (LiDFOB, CAS No.: 409071-16-5)

In the composition of the electrolyte, a content “wt %” of each additive is based on 100 wt of the total electrolyte (lithium salt+non-aqueous organic solvent+first additive+second additive).

### Example 2

An electrolyte was prepared in the same manner as in Example 1, except that 0.5 wt % of the first additive and 0.5 wt % of the second additive were added.

### Example 3

An electrolyte was prepared in the same manner as in Example 1, except that 0.5 wt % of the first additive and 1 wt % of the second additive were added.

### Example 4

An electrolyte was prepared in the same manner as in Example 1, except that 0.5 wt % of the first additive and 1.5 wt % of the second additive were added.

### Example 5

An electrolyte was prepared in the same manner as in Example 1, except that 0.5 wt % of the first additive and 2 wt % of the second additive were added.

### Example 6

An electrolyte was prepared in the same manner as in Example 1, except that 1 wt % of the first additive and 1 wt % of the second additive were added.

### Comparative Example 1 Ref

An electrolyte was prepared in the same manner as Example 1, except that no additives were added.

### Comparative Example 2

An electrolyte was prepared in the same manner as in Example 1, except that 0.5 wt % of the first additive was added and the second additive was not added.

### Comparative Example 3

An electrolyte was prepared in the same manner as in Example 1, except that the first additive was not added and 1 wt % of the second additive was added.

### Manufacture of Rechargeable Lithium Battery Cells

LiCoO₂ as a positive electrode active material, polyvinylidene fluoride as a binder, and acetylene black as a conductive material were mixed together respectively in a weight ratio of 96:3:1, and then, dispersed in N-methyl pyrrolidone to prepare a positive electrode active material slurry.

The positive electrode active material slurry was coated on a 15 μm-thick Al foil, dried at 100° C., and pressed to manufacture a positive electrode.

Artificial graphite as a negative electrode active material, a styrene-butadiene rubber binder, and carboxylmethyl cellulose in a weight ratio of 98:1:1 were dispersed in distilled water to prepare a negative electrode active material slurry.

The negative electrode active material slurry was coated on a 10 μm-thick Cu foil, dried at 100° C., and pressed to manufacture a negative electrode.

An electrode assembly was manufactured by assembling the positive electrode, the negative electrode, and a separator made of polyethylene having a thickness of 10 μm, and the electrolytes according to Examples 1 to 6 and Comparative Examples 1 to 3 were injected, respectively to manufacture each rechargeable lithium battery cell.

### Evaluation Examples

The rechargeable lithium battery cells manufactured using the electrolytes according to Examples 1 to 6 and Comparative Examples 1 to 3 were evaluated as follows, and the evaluation results are shown in Tables 1 to 3.

### Evaluation 1: Evaluation of High-Voltage (4.53 V) and High-Temperature (45° C.) Charge/Discharge Cycle Characteristics

The rechargeable lithium battery cells were charged and discharged 200 times under the conditions of 45° C., 2.0 C charge (CC/CV, 4.53 V, 0.025 C Cut-off)/1.0 C discharge (CC, 3V Cut-off).

The thickness increase rates were calculated according to Equation 1, capacity retention rates were calculated according to Equation 2, and the results are shown in Table 1.

$$Thickness increase rate = \{ ( Full charge thickness after 200 cycles ) - ( Full charge thickness after 1 cycle ) \} / ( Full charge thickness after 1 cycle ) ⋆ 100 \qquad Equation 1$$

In Equation 1, “full charge thickness” refers to a thickness of the rechargeable lithium battery cells measured after charging at SOC 100% (if the total charge capacity of the battery is set at 100%, charged to 100% charge capacity) after each cycle.

$$Capacity retention rate = ( discharge capacity after 4 \; 00 cycles / discharge capacity after 1 cycle ) ⋆ 100 \qquad Equation 2$$

TABLE 1

| | | | High-temperature charge and | |
|---|---|---|---|---|
| | | | discharge characteristics of | |
| | Additive content in | | rechargeable lithium battery cells | |
| | electrolyte (wt %) | | Thickness | Capacity |
| | First | Second | increase rate | retention rate |
| | additive | additive | (%) | (%) |
| Comparative | 0 | 0 | 20 | 70 |
| Example 1 | | | | |
| Comparative | 0.5 | 0 | 18.7 | 72 |
| Example 2 | | | | |
| Comparative | 0 | 1 | 18.9 | 75 |
| Example 3 | | | | |
| Example 1 | 0.5 | 0.25 | 18.2 | 74 |
| Example 2 | 0.5 | 0.5 | 17.3 | 79 |
| Example 3 | 0.5 | 1 | 15.1 | 84 |
| Example 4 | 0.5 | 1.5 | 16.8 | 81 |
| Example 5 | 0.5 | 2 | 17.6 | 80 |
| Example 6 | 1 | 1 | 18.6 | 76 |

### Evaluation 2: Evaluation of Storage Characteristics at High Temperature

The rechargeable lithium battery cells before stored at a high temperature were measured with respect to initial DC internal resistance (initial DC-IR) by ΔV/ΔI (voltage change/current change).

After making a maximum energy state inside the rechargeable lithium battery cells lithium battery to a full-charge state (SOC 100%) and then, storing the cells at a high temperature (60° C.) for 28 days in this state, the cells were measured with respect to DC resistance (DC-IR after 28 days).

A DC-IR increase rate was calculated according to Equation 3, and the results are shown in Table 2.

$$D C I R increase rate = ( D C - I R after 28 days ) / ( initial D C - I R ) ⋆ 100 \qquad Equation 3$$

TABLE 2

| | Additive content in | | Storage characteristics at high |
|---|---|---|---|
| | electrolyte (wt %) | | temperature of rechargeable |
| | First | Second | lithium battery cells |
| | additive | additive | DC-IR increase rate (%) |
| Comparative | 0 | 0 | 180 |
| Example 1 | | | |
| Comparative | 0.5 | 0 | 177 |
| Example 2 | | | |
| Comparative | 0 | 1 | 170 |
| Example 3 | | | |
| Example 1 | 0.5 | 0.25 | 175 |
| Example 2 | 0.5 | 0.5 | 163 |
| Example 3 | 0.5 | 1 | 154 |
| Example 4 | 0.5 | 1.5 | 156 |
| Example 5 | 0.5 | 2 | 162 |
| Example 6 | 1 | 1 | 164 |

### SUMMARY

Referring to Tables 1 and 2, the electrolytes (Examples 1 to 6) concurrently (e.g., simultaneously) including the first and the second additives improved high voltage and high-temperature characteristics of the rechargeable lithium battery cells, compared with the electrolyte including no additives at all (Comparative Example 1) and the electrolyte including one type (or kind) of additive out of the two types (or kinds) of additives (Comparative Examples 2 and 3).

The electrolytes concurrently (e.g., simultaneously) including the first and second additives (Examples 1 to 6) suppressed an increase in a thickness, even though the rechargeable lithium battery cells were charged and discharged under a high-voltage and high-temperature condition, and improved a cycle-life of the cells.

In addition, the electrolytes concurrently (e.g., simultaneously) including the first and second additives (Examples 1 to 6) suppressed an increase in resistance, even though the rechargeable lithium battery cells were stored at a high temperature.

On the other hand, in the electrolytes concurrently (e.g., simultaneously) including the first and second additives (Examples 1 to 6), a content of each of the additives and a mixing ratio thereof may be controlled according to suitable or desired characteristics.

While the subject matter of this disclosure has been described in connection with what is presently considered to be practical example embodiments, it is to be understood that the disclosure is not limited to the disclosed embodiments, but, on the contrary, is intended to cover various modifications and equivalent arrangements included within the spirit and scope of the appended claims, and equivalents thereof.

Description of symbols

| | |
|---|---|
| 100: rechargeable lithium battery | 10: positive electrode |
| 11: positive electrode lead tab | 12: positive terminal |
| 20: negative electrode | 21: negative electrode lead tab |
| 22: negative terminal | 30: separator |
| 40: electrode assembly | 50: case |
| 60: sealing member | 70: electrode tab |
| 71: positive electrode tab | 72: negative electrode tab |

What is claimed is:

1. An electrolyte for a rechargeable lithium battery, comprising:
a lithium salt;
a non-aqueous organic solvent;
a first additive represented by Chemical Formula 1; and
a second additive represented by Chemical Formula 2: 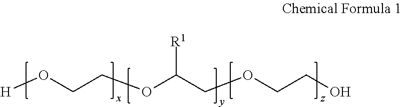
wherein, in Chemical Formula 1,
R¹ is a hydrogen atom or a C1 to C10 alkyl group; and
x, y, and z are each independently integers from 1 to 20; 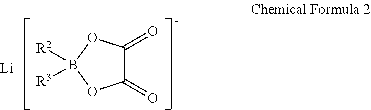
wherein, in Chemical Formula 2,
R² and R³ are each independently a halogen atom, or a C1 to C10 fluoroalkyl group.

2. The electrolyte as claimed in claim 1, wherein:
R¹ is a methyl group.

3. The electrolyte as claimed in claim 1, wherein:
a number average molecular weight of the first additive is about 500 to about 10,000 g/mol.

4. The electrolyte as claimed in claim 1, wherein:
both R² and R³ are fluorine atoms.

5. The electrolyte as claimed in claim 1, wherein:
the first additive is included in an amount of about 0.1 to about 5 wt % based on a total amount of the electrolyte.

6. The electrolyte as claimed in claim 1, wherein:
the second additive is included in an amount of about 0.1 to about 5 wt % based on a total amount of the electrolyte.

7. The electrolyte as claimed in claim 1, wherein:
a weight ratio of the first additive and the second additive is about 5:1 to about 1:10.

8. The electrolyte as claimed in claim 1, wherein:
the non-aqueous organic solvent comprises a carbonate-based solvent and a propionate-based solvent.

9. The electrolyte as claimed in claim 8, wherein:
the propionate-based solvent is included in an amount of greater than or equal to about 70 volume % based on a total amount of the non-aqueous organic solvent.

10. The electrolyte as claimed in claim 1, wherein:
the lithium salt is LiPF₆.

11. The electrolyte as claimed in claim 1, wherein
a concentration of the lithium salt is about 0.1 M to about 2.0 M.

12. A rechargeable lithium battery, comprising:
a positive electrode comprising a positive electrode active material;
a negative electrode comprising a negative electrode active material; and
the electrolyte as claimed in claim 1.

13. The rechargeable lithium battery as claimed in claim 12, wherein:
the positive electrode active material comprises lithium nickel-based oxide, lithium cobalt-based oxide, lithium manganese-based oxide, a lithium iron phosphate-based compound, cobalt-free lithium nickel-manganese-based oxide, or a combination thereof.

14. The rechargeable lithium battery as claimed in claim 12, wherein:
the negative electrode active material comprises a carbon-based negative electrode active material, a Si-based negative electrode active material, or a combination thereof.

15. The rechargeable lithium battery as claimed in claim 12, wherein:
the rechargeable lithium battery has an upper charge limit voltage of greater than or equal to about 4.5 V.
